(19) United States
(12) Patent Application Publication
(10) Pub. No.: US 2006/0162853 A1
(43) Pub. Date: Jul. 27, 2006

(54) Printed, embossed and metallized material

(75) Inventor: Caspar M. T. Elbers, Kwazulu-Natal Province (ZA)

Correspondence Address: MARSHALL, GERSTEIN & BORUN LLP, 233 S. WACKER DRIVE, SUITE 6300, SEARS TOWER, CHICAGO, IL, 60606, US

(73) Assignee: NAMPAK PRODUCTS LIMITED, Johannesburg, Gauteng Province (ZA)

(21) Appl. No.: 10/517,551

(22) PCT Filed: May 23, 2003
(86) PCT No.: PCT/IB03/01977

§ 371 Date: Jun. 15, 2005

(30) Foreign Application Priority Data
Jun. 10, 2002 (ZA) 2002/4640

(51) Int. Cl. B41M 1/24; B31F 1/07; B05D 3/00; B29D 7/00; B32B 38/14; B32B 38/06

(52) U.S. Cl. 156/209; 156/277; 156/324; 156/387; 427/177; 427/289; 427/402; 427/404; 427/294

(57) ABSTRACT

The invention provides a process for producing printed material comprising an elongated web of flexible sheet material. The process includes the process steps of printing an embossing coating on at least a portion of a surface of a major face of a web of the sheet material, embossing the embossing coating printed on the major face by means of an optically variable device, and metallising at least a portion of the surface of the major face with a metal coating. The invention also provides an apparatus or installation for producing the printed material. The apparatus or installation 10 comprises a plurality of process stations which include an embossing coating printing station 24, an embossing station 32, and a metallising station 40. Further, the invention provides a flexible printed material comprising a web of flexible sheet material, whenever produced by the process or apparatus or installation 10 according to the invention.

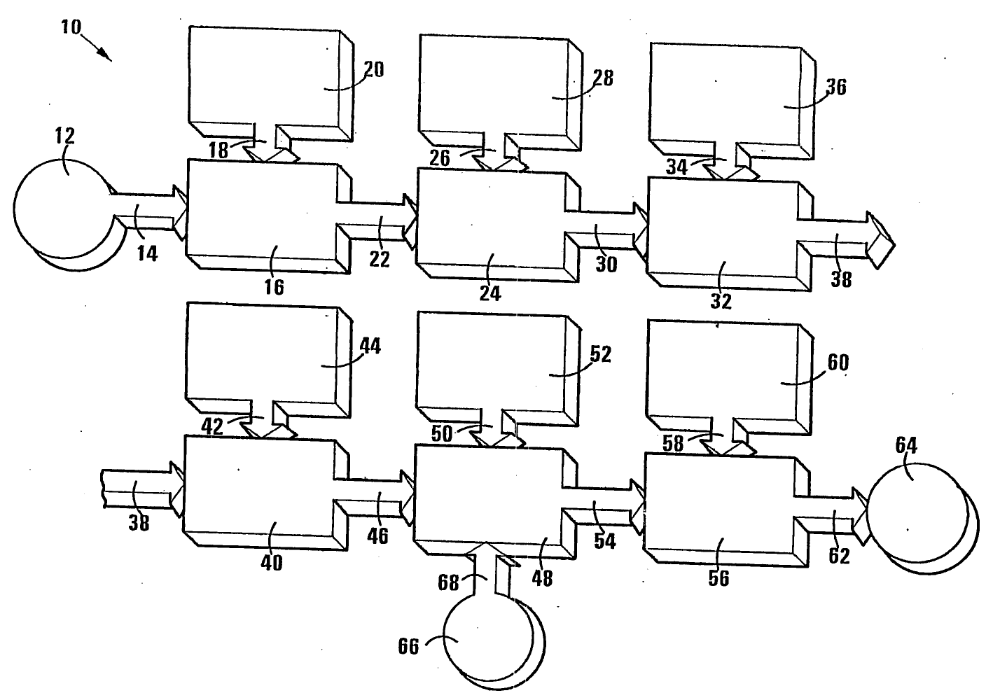

THIS INVENTION relates to printed material. More particularly, the invention relates to a process for producing printed material suitable for, but not limited to, packaging. The invention also relates to an apparatus or installation for producing such printed material, and to a flexible printed material whenever produced in accordance with the process or by means of the apparatus or installation.

According to the invention there is provided a process for producing printed material comprising an elongated web of flexible sheet material, the process including the process steps of:
printing an embossing coating on a surface of a major face of a web of said sheet material;
embossing the embossing coating printed on said major face by means of an optically variable device; and
metallising said surface of said major face with a metal coating, to produce a web of flexible sheet material having a major face which is embossed, said major face being metallised,
the printing and the embossing being carried out in-line and continuously until a desired length of the surface of the web has been embossed;
the web being advanced continuously past a series of work stations where the in-line process steps are respectively carried out, the series including a printing station where the printing of the embossing coating continuously takes place and an embossing station, following the printing station, where the embossing continuously takes place;
the printing of the embossing coating being on a portion of said surface of said major face; and
the metallising being of the entire surface of said major face,
so that said major face of the web is partially embossed, the whole of said major face being metallised.

More particularly, the flexible sheet material may be a transparent flexible polymeric plastics film.

The process may include the further step of colour-printing said major face of the web, the colour-printing being carried out continuously and in-line with the printing of the embossing coating and in-line with the embossing. Preferably, the colour-printing is confined to at least one unembossed portion of the surface of said major face.

The colour-printing may be by means of a printing cylinder using a gravure printing technique, although any other suitable printing technique can naturally be employed instead. Preferably, the colour-printing cylinder forms part of a gravure printing press.

In particular, the colour-printing may be carried out prior to the printing of the embossing coating.

In other words, the colour-printing may be carried out prior to the metallising and optionally prior to the printing of the embossing coating, between the printing of the embossing coating and the embossing, or after the embossing, the colour-printing being carried out in-line with the printing of the embossing coating and in-line with the embossing, preferably being confined to the unembossed portion of the surface of said major face. In this regard, the embossed portion and/or the unembossed portion may extend continuously along the full length of the web, or one or both of these portions may be divided into separate parts, which may be spaced from one another; and the embossing and/or the arrangement of the portions may be such as to provide the embossed web with one or more repeating patterns. In this context colour-printing includes printing with pigments which are white, black or grey, although these are not strictly speaking colours.

More particularly, the metallising step and any additional process steps, other than in-line printing and embossing steps, may be carried out batchwise.

The embossing by means of an optically variable device may be selected from the group consisting of holographic embossing (two- or three-dimensional), stereographic embossing (to produce stereographs), diffraction grating embossing (by means of diffraction gratings), dot matrix embossing and combinations thereof (using various optically variable devices). Preferably, the embossing is holographic embossing. In particular, as indicated above, the embossing may be such as to provide the embossed web with an at least partially repeating embossed pattern.

The process may also include the further process step of laminating the embossed metallised web with a backing web of flexible sheet material, to provide a laminated composite material, in which the embossing, the metal coating and any colour-printing are sandwiched between the webs so that the embossed metallised web is reverse-printed, at least one of the webs being transparent. The film of flexible sheet material of the backing web, like the flexible sheet material of the embossed metallised web, may, but need not be, transparent. Thus, the step of laminating the embossed metallised web with a backing web may, for example, be by adhesively securing the webs together by means of an adhesive, to provide the laminated composite material. Further, the process may include the steps of slitting the embossed metallised web lengthwise into at least two strips, and rolling said strips into rolls. Naturally, instead of being rolled into rolls, the strips may be cut transversely into individual sheets.

In other words, the process may include the further process step of laminating the embossed metallised web with a backing web of flexible sheet material, which may or may not be of flexible polymeric plastics film, and may or may not be transparent, for example by adhesively securing the webs together by means of an adhesive, to provide a laminated composite printed material, in which the embossed coating, the metal coating and any colour-printing are sandwiched between the webs so that the embossed metallised web is reverse-printed, the laminated composite material typically being slit lengthwise prior to finally being rolled into rolls or cut transversely into individual sheets.

While each of said webs may naturally be made of paper or flexible board, each said web is preferably made of a polymeric material selected from the group consisting of polyesters, polypropylenes, polyethylenes and polyvinyl chlorides, and mixtures, blends and copolymers thereof. Preferably, the polymeric material is selected from polysters and polypropylenes, the metallising being by vacuum metallising.

In particular, the metallising step may be carried out by means of aluminium, although, naturally, other metals and other metallising techniques can, if desired, be used.

The embossing coating may be solvent-based, the embossing coating being printed by means of a printing cylinder. Instead, the embossing coating can be water-based, or indeed solvent-free. Preferably, the embossing coating is provided by the printing cylinder using a gravure printing technique, the cylinder forming part of a gravure printing press. In other words, a gravure printing technique may be employed, the cylinder forming part of a gravure printing press, for example, a rotogravure printing press.

Similarly, the embossing may be by means of an embossing cylinder, carrying a holographically engraved printing surface. The engraved printing surface may be engraved on the cylinder itself, or may be provided by one or more holographically engraved shims mounted on the embossing cylinder. Preferably, the embossing cylinder also forms part of a gravure printing press, preferably the same press as comprises the cylinder used for printing the embossing coating. When colour-printing is employed, this may likewise be by means of a printing cylinder and may employ a gravure printing technique, this printing cylinder conveniently being part of the same gravure press of which the cylinders for printing the embossing coating and for embossing the embossing coating also form part, so that a single gravure press is employed for the process. In this case, if an eight-colour gravure printing press is used, up to six of its cylinders can be used for colour-printing, at separate stations, all in-line, separate and distinct from the embossing coating printing station and the embossing station.

More particularly, as indicated above, the embossing step and each printing step may be carried out by separate cylinders forming part of a single gravure printing press.

The invention extends to an apparatus or installation for producing printed material, the apparatus or installation comprising a plurality of processing stations, the processing stations including;
an embossing coating printing station for printing an embossing coating on a surface of a major face of an elongated web of flexible sheet material;
an embossing station for embossing the embossing coating printed on the web at the printing station; and
a metallising station for metallising said surface of said major face,
the printing station and the embossing station being arranged in-line;
the apparatus or installation being arranged and constructed continuously to advance an elongated web of flexible sheet material in succession past said printing station and said embossing station; and
the embossing coating printing station being for printing the embossing coating on a portion of said surface of the major face.

Conveniently the apparatus or installation is arranged and constructed to advance the elongated web of flexible sheet material past the embossing station and then to the metallising station, to facilitate metallising the entire surface of said major face, or part thereof.

The apparatus or installation may include at least one colour-printing station, arranged in-line with the embossing coating printing station and the embossing station, for colour-printing a coloured coating on an uncoated portion of the surface of said major face.

Each processing station, other than said printing stations and embossing station, may be arranged for batchwise processing of the web.

In a convenient embodiment of the apparatus or installation, each printing station and the embossing station may form part of a single gravure printing press having a plurality of cylinders, each printing station and the embossing station being arranged in-line and each comprising one of the cylinders of the press.

The metallising station may comprise a vacuum-metallising station, for vacuum-metallising the major face, with a metal such as aluminium.

The apparatus or installation may also include a laminating station for laminating said major face of the web, after the metallising, to a backing web of flexible sheet material; the apparatus or installation including an optional slitting station for slitting the metallised web into portions, and an optional rolling station for rolling each metallised web or web portion up into at least one roll. Naturally, instead, the rolling station may be replaced by a cutting station for cutting each metallised web or web portion into individual sheets.

The invention extends to flexible printed material comprising a web of flexible sheet material, for example transparent polymeric plastics film, whenever produced by the process described above, and/or whenever produced by means of the apparatus or installation described above.

In particular, the web may comprise an embossed portion and an unembossed portion which respectively extend continuously along the full length of the web. Preferably, the embossed portion and unembossed portion are divided into separate parts, the parts being spaced from one another and alternating along the length of the web.

The portions may be arranged such as to provide the web with at least one repeating pattern.

While the invention naturally contemplates using webs which are embossed and metallised, and backing webs, which are of paper or flexible board, the web which is embossed and metallised, and any backing web used, are conveniently made from a member selected from the group of polymeric plastics materials consisting of polyesters, polypropylenes, polyethylenes, and polyvinyl chlorides, and mixtures, blends and copolymers thereof.

In a particular embodiment of the invention, the flexible printed material may be in the form of at least one bank note.

In another particular embodiment of the invention, the flexible printed material may be in the form of a packaging material.

The invention will now be described, by way of non-limiting illustrative example, with reference to the accompanying diagrammatic drawing, in which the single FIGURE shows a schematic flow diagram of a process according to the present invention.

In the drawing, in which the flow diagram of the present invention is generally designated by reference numeral 10, a plurality of process stages or work stations are illustrated, interconnected by a plurality of flow paths or flow lines along which materials undergoing the process of the present invention are moved, to and past the various stations. Process steps are carried out at the various stations, which are shown associated with items of process equipment, connected thereto by process lines, indicating the process steps which are carried out thereby. Reference numeral 10 thus generally designates an apparatus or installation for carrying out the process of the present invention.

The installation 10 comprises a supply or store 12 of unprinted flexible sheet material such as polyester (PET), bi-axially oriented polypropylene (BOPP), polyvinyl chloride (PVC), paper, flexible board or the like, in the present example, say, PET. The store 12 is shown connected by flow line 14 to a colour-printing station 16 which receives process input, designated by process line 18, from a printing cylinder 20 of a rotogravure printing press. Flow line 22 then leads from station 16 to an embossing coating printing station 24, which receives process input, designated by process line 26, from a further printing cylinder 28 of said rotogravure printing press.

From the station 24 flow line 30 leads to an embossing station 32 which receives process input along process line 34 from a yet further printing cylinder 36 of said rotogravure printing press, which cylinder 36 is holographically engraved. Instead, cylinder 36 may carry holographically engraved shims mounted thereon.

Flow line 38 in turn leads from station 32 to a metallising station 40, which receives process input along process line 42 from a vacuum-metalliser 44. From station 40 flow line 46 leads to a laminating station 48 which is supplied along process line 50 with process input from a laminator 52.

Flow line 54 leads from station 48 to a slitting station 56 which receives process input along process line 58 from a slitter 60; and flow line 62 leads from station 56 to a product store 64.

Finally, a supply or store 66 of sealant film, likewise polyester film, is shown feeding along flow line 68 into laminating station 48.

In accordance with the process of the invention a web in continuous strip form, of unprinted polyester film is fed from a roll thereof at the store 12 along flow line 14 to and past the colour-printing station 16 where the web receives, on a portion thereof, a reverse-printed colour coating along process line 18 from cylinder 20. The web then moves on from station 16 along flow line 22 to the embossing coating printing station 24, where it receives, on a different and as yet unprinted portion thereof, a reverse-printed embossing coating, along process line 26 from cylinder 28.

The web then moves on from station 24 along flow line 30 to embossing station 32, where, on the portion printed with embossing coating, it is reverse-printed with holographic embossing by process input along line 34 from engraved cylinder 36. The web then moves on along line 38 to the metallising station, where the entire printed surface thereof receives a reverse-printed metallising coating |along process line 42 from the metalliser 44.

The web then moves on from station 40 along flow line 46 to the laminating station 48 where it receives laminating process input from laminator 52 along process line 50, being laminated at station 48 to a web of polyester laminating film, moving from store 66 along flow line 68 to station 48. The laminated web then moves on along flow line 54 to slitting station 56 where it receives slitting process input from the slitter 60 along process line 58, and is longitudinally slit into longitudinally extending portions. Finally, the slit portions move along flow line 62 to the store 64 via a rolling station (not shown) where process input is provided which rolls the laminated film slit portions into rolls, which rolls move along line 62 to the store 64.

With regard to the aforegoing, it should be noted that the process of the present invention illustrated in the drawings is a continuous (not batchwise) in-line process, with regard to the colour-printing, the printing with embossing coating, and the embossing in which the web of film from the store 12 is moved as a continuous web, either continuously or intermittently, as far as the embossing station 32. Thereafter, in the embodiment illustrated in the drawing, the succeeding process steps are carried out batchwise on the web, with regard to the metallising, the laminating, the slitting and the rolling.

It should further be noted that flow lines 14, 22, 30, 38, 46, 54, 62 and 68 are flow lines along which the webs move from stores 12 and 66, either separately or together after lamination thereof, from one process station to another, the colour-printing, embossing coating printing and embossing process stations respectively 16, 24 and 32 being arranged in-line. In contrast, the process lines 18, 26, 34, 42, 50 and 58 are not intended necessarily to indicate material flow, but rather the application of process input or process steps at the various stations, by the plant or equipment associated with the respective stations, to the web passing to and past the stations. There will naturally be a flow of colour-printing material associated with line 18, a flow of embossing coating material associated with line 26, and a flow of metallising metal, say aluminium vapour, associated with line 42, but no material flow will take place along any of lines 34, 50 or 58.

An advantage of the process as described above with reference to the drawing, is that it employs an at least partially in-line process in which a holographic coating is applied to a starting film which is then holographically embossed, the printing of the embossing coating and the embossing thereof being applied to only portions of the starting film, where required, and not to the remainder thereof. This has particular advantages compared with a process which employs a pre-holographically embossed starting film, all of which is embossed, including unnecessary holographic embossing on parts of the film intended to be colour-printed where such embossing is wasted. Furthermore, pre-embossed film, apart from being expensive, is generally available in a limited number of different embossed designs. Thus, apart from reducing the expensive embossing, flexibility in the designs-used is promoted, particularly when engraved shims are employed on the embossing cylinder. Using a rotogravure press, embossing can be carried out on desired portions of the film and colour-printing can be carried out on other desired portions of the film, in an in-line process of relatively reduced cost having enhanced artistic possibilities. In particular, it makes possible the embossing of corporate logos or brand names on the product holographically, which cam assist in resisting counterfeiting, in particular, of banknotes, and can improve shelf-appeal of packaging made from the film.

1. A process for producing printed material comprising an elongated web of flexible sheet material, the process Including the process steps of
printing an embossing coating on a surface of a major face of a web of said sheet material;
embossing the embossing coating printed on said major face by means of an optically variable device; and
metallising said surface of said major face with a metal coating,
to produce a web of flexible sheet material having a major face which is embossed, said major face being metallised,
the process being characterized In that
the printing and the embossing are carried out in-line and continuously until a desired length of the surface of the web has been embossed;
the web Is advanced continuously past a series of work stations where the in-line process steps are respectively carried out, the series including a printing station where the printing of the embossing coating continuously takes place and an embossing station, following the printing station, where the embossing continuously takes place;
the printing of the embossing coating is on a portion of said surface of said major face; and
the metallising is of the entire surface of said major face,
so that said major face of the web is partially embossed, the whole of said major face being metallised.

2. A process as claimed In claim 1 characterised in that the flexible sheet material is a transparent flexible polymeric plastics film.

3. A process as claimed in claim 1, characterised in that it includes the further step of colour-printing said major face of the web, the colour-printing being carried out continuously and in-fine with the printing of the embossing coating and Inline with the embossing.

4. A process as claimed In claim 3, characterised in that the colour-printing Is confined to at least one unembossed portion of the surface of said major face.

5. A process as claimed in claim 3, characterised In that the colour-printing is by means of a printing cylinder using a gravure printing technique.

6. A process as claimed in claim 5, characterised in that the colour-printing cylinder forms part of a gravure printing press.

7. A process as claimed in claim 3, charcterised in that the colour-printing is carried out prior to the printing of the embossing coating.

8. A process as claimed in claim 1, characterised in that the metallising step and any additional process steps, other than in-line printing and embossing steps, are carried out batchwise.

9. A process as claimed in claim 1, characterised in that the embossing by means of an optically variable device is selected from the group consisting of holographic embossing, stereographic embossing, diffraction ‘grating embossing, dot matrix embossing and combinations thereof.

10. A process as claimed in claim 9, characterised in that the embossing Is holographic embossing.

11. A process as claimed in claim 1, characterised in that the embossing Is such as to provide the embossed web with an at least partially repeating embossed pattern.

12. A process as claimed in claim 1, characterised in that it includes the further process step of laminating the embossed metallised web with a backing web of flexible sheet material, to provide a laminated composite material, in which the embossing, the metal coating and any colour-printing are sandwiched between the webs so that the embossed metallised web Is reverse-printed, at least one of the webs being transparent.

13. A process as claimed in claim 1, charaterised in that it includes the steps of slitting the embossed metallised web lengthwise into at least two strips, and rolling said strips into rolls.

14. A process as claimed in claim 1, characterised in that each said web is made of a polymeric material selected from the group consisting of polyesters, polypropylenes, polyethylenes and polyvinyl chlorides, and mixtures, blends and copolymers thereof.

15. A process as claimed in claim 14, characterised In that the polymeric material is selected from polysters and polypropylenes, the metallising being by vacuum metallising.

16. A process as claimed in claim 1, characterised In that the metallising step is carried out by means of aluminium.

17. A process as claimed in claim 1, characterised in that the embossing coating is solvent-based, the embossing coating being printed by means of a printing cylinder.

18. A process as claimed in claim 17, characterised in that the embossing coating Is provided by the printing cylinder using a gravure printing technique, the cylinder forming part of a gravure printing press.

19. A process as claimed in claim 1, characterised in that the embossing is by means of an embossing cylinder, carrying a holographically engraved cylindrical surface.

20. A process as claimed in claim 19, characterised In that the embossing cylinder forms part of a gravure printing press.

21. A process as claimed in claim 1, characterised in that the embossing step and each printing step are carried out by separate cylinders forming part of a single gravure printing press.

22. An apparatus or Installation for producing printed material, the apparatus or installation comprising a plurality of process stations, the process stations including:
an embossing coating printing station for printing an embossing coating on
a surface of a major face of an elongated web of flexible sheet material;
an embossing station for embossing the embossing coating printed on the web at the printing station; and
a metallising station for metallising said surface of said major face, the apparatus or installation being characterised in that:
the printing station and the embossing station are arranged in-line;
the apparatus or installation is arranged and constructed continuously to advance an elongated web of flexible sheet material in succession past said printing station and said embossing station; and
the embossing coating printing station Is for printing the embossing coating on a a portion of said major surface of the major face.

23. An apparatus or installation as claimed In claim 22, characterised in that: it is arranged and constructed to advance the elongated web of flexible sheet material past the embossing station and then to the metallising station.

24. An apparatus or installation as claimed in claim 23, characterised in that: it includes at least one colour-printing station, arranged in-line with the embossing coating printing station and the embossing station, for colour-printing a coloured coating on an uncoated portion of the surface of said major face.

25. An apparatus or installation as claimed in claim 22, characterised in that: each processing station (40, 48, 56), other than said printing stations and embossing station, is arranged for batchwise processing of the web.

26. An apparatus or installation as claimed in claim 22,
characterised in that each printing station and the embossing station form part of a single gravure printing press having a plurality of cylinders, each printing station and the embossing station being arranged in-line and each comprising one of the cylinders of the press.

27. An apparatus or installation as claimed in claim 22, characterised in that the metallising station comprises a vacuum-metallising station, for vacuum-metallising the major face.

28. An apparatus or installation as claimed in claim 22, characterised in that it includes a laminating station for laminating said major face of the web, after the metallising, to a backing web of flexible sheet material.

29. An apparatus or installation as claimed in claim 22, characterised in that it includes a slitting station for slitting the metallised web into portions.

30. An apparatus or Installation as claimed in claim 22, characterised in that it includes a rolling station for rolling each metallised web or web portion up into at least one roll.
